(19) United States
(12) Patent Application Publication
(10) Pub. No.: US 2013/0042171 A1
(43) Pub. Date: Feb. 14, 2013

(54) METHOD AND SYSTEM FOR GENERATING AND MANAGING ANNOTATION IN ELECTRONIC BOOK

(71) Applicants: Jin Hong Yang, Daejeon (KR); Jun Kyun Choi, Daejeon (KR); Hyo Jin Park, Daejeon (KR); Seok Hyun Song, Daejeon (KR); Sang Min Park, Daejeon (KR); Na Gyeong An, Gyeonggi-do (KR); Hyun Mi Kim, Daejeon (KR)

(72) Inventors: Jin Hong Yang, Daejeon (KR); Jun Kyun Choi, Daejeon (KR); Hyo Jin Park, Daejeon (KR); Seok Hyun Song, Daejeon (KR); Sang Min Park, Daejeon (KR); Na Gyeong An, Gyeonggi-do (KR); Hyun Mi Kim, Daejeon (KR)

(73) Assignee: Korea Advanced Institute of Science and Technology, Daejeon (KR)

(21) Appl. No.: 13/287,445

(22) Filed: Nov. 2, 2011

(30) Foreign Application Priority Data
Aug. 12, 2011 (KR) 10-2011-0080438
Aug. 16, 2011 (KR) 10-2011-0081167

(51) Int. Cl. G06F 17/00

(52) U.S. Cl. 715/230

(57) ABSTRACT

A method of generating and managing an annotation on an electronic book (eBook) and a system thereof are provided. A user terminal that provides a viewer function with respect to digital content may include a touch sensing display, at least one processor, a memory, and at least one program, and the at least one program is stored in the memory so as to be executed by the at least one processor, and includes a content display code to display a content layer on which the digital content is rendered, on a screen of the touch sensing display, and an annotation storage code to generate annotation data by applying, to an object selected by a user, an application associated with an annotation in response to a request from the user, and to store the generated annotation data to be associated with the user.

### CROSS-REFERENCE TO RELATED APPLICATIONS

This application claims the benefit under 35 U.S.C. §119 of Korean Patent Application Nos. 10-2011-0080438, filed Aug. 12, 2011, and 10-2011-0081167, filed Aug. 16, 2011, which are hereby incorporated by reference in their entirety.

### BACKGROUND

1. Field of the Invention

The present invention relates to a method and system that may generate various annotations on content being read by a user in an electronic book environment, and that may manage items in which annotations are made.

2. Description of the Related Art

An electronic book is a digital book, which is produced by recording information associated with characters or images in an electronic medium and thus, may be used as though it is a real book. The electronic book may be referred to as an eBook. Instead of obtaining information from a conventional paper book, a user may acquire information from the eBook digitalized based on a hypertext mark-up language (HTML) and an extensible mark-up language (XML), which are the standard languages of the Internet, via a viewer program of a personal computer (PC) or a dedicated terminal. The eBook is a form of digital content service created by state-of-the-art information technologies. For users, the eBook is less expensive than a paper book, and is more convenient than a paper book since users are able to purchase a necessary portion separately. For publishing companies, the eBook is economical in terms of production costs and distribution costs, and updating content of the eBook is easily accomplished.

Conventional technologies have provided various educational services based on an eBook. However, the conventional eBook merely provides a function of bookmarking and a function of viewing content. That is, conventional eBook environments enable users to merely read content. A major drawback of the conventional eBook is an inability to generate an annotation of a desired standard of a user in a corresponding content. Users are not able to share annotations created by the users in a different user environment, that is, a different eBook viewer, and thus, application of the annotations may be limited.

Therefore, the present invention provides a method and system that generates various annotations so that the eBook is utilized in varied forms, as opposed to merely being used for reading content.

### BRIEF SUMMARY

An aspect of the present invention provides a method and system that generates an annotation based on various functions, for example, a memo, underlining, and the like, in an electric book (eBook) environment.

Another aspect of the present invention provides a method and system that provides a more convenient user interface (UI) of an eBook so that an annotation on a content is readily managed.

Still another aspect of the present invention provides a method and system that automatically extracts an item in which a plurality of annotations is written by a user in an eBook environment.

Yet another aspect of the present invention provides a method and system that provides a UI environment, so that an item in which a plurality of annotations is written may be recognized intuitively.

Further another aspect of the present invention provides a method and system that stores annotations created by a user in a server in a network environment, so that a user terminal may download and playback the annotations.

According to an aspect of the present invention, there is provided a user terminal that provides a viewer function with respect to digital content, the terminal including a touch sensing display, at least one processor, a memory, and at least one program, and the at least one program is stored in the memory so as to be executed by the at least one processor, and includes a content display code to display a content layer on which the digital content is rendered, on a screen of the touch sensing display, an object recognition code to recognize an object selected by a user from the digital content by a touch input of the user to the touch sensing display, and an annotation storage code to generate annotation data by applying, to the object, an application associated with an annotation in response to a request from the user, and to store the generated annotation data to be associated with the user.

The annotation storage code may store the annotation data to have a data structure including at least one of an identification (ID) of the digital content, a positional value of the object based on a rendering of the digital content, and an actual data value corresponding to the object.

The program may further include an annotation display code to display an annotation layer on which the annotation data is rendered, on the content layer in a form of an overlay.

The program may further include an input processing code to process the touch input by enabling the touch input to go through a dispatcher of the annotation layer and transferring the touch input to the content layer when the touch input is input while the annotation layer is being overlaid on the content layer.

When the touch input is inputted, the input processing code calls an application corresponding to a dispatcher of the annotation layer when the dispatcher associated with a user input exists in the annotation layer, and an application corresponding to a dispatcher of the content layer when the dispatcher associated with the user input is absent in the annotation layer and the dispatcher associated with the user input exists in the content layer.

The program may further include an annotation count code to count, for each item of the digital content, a number of annotation data generated in a corresponding item, and an annotation provision code to provide the number of annotation data for each item, in response to a request from the user.

According to another aspect of the present invention, there is provided a server that provides an on-line service associated with digital content to a user terminal that accesses the server via an Internet connection, the server including a content managing module to provide the digital content to the user terminal, an annotation managing module to recognize an object selected by a user from the digital content, and to generate annotation data by applying an application associated with an annotation to the object in response to a request from the user, and an annotation information database (DB) to store the annotation data to be associated with the user and to maintain the stored annotation data, and the user terminal includes a touch sensing display so as to display the digital content provided from the server on a screen of the touch sensing display, and the annotation managing module recognizes the object by a touch input of the user to the touch sensing display.

The annotation managing module may render the annotation data on an annotation layer that is overlaid on a content layer.

When the touch input is inputted while the annotation layer is being overlaid on the content layer, the user terminal may call an application corresponding to a dispatcher of the annotation layer when the dispatcher associated with a user input exists in the annotation layer, and an application corresponding to a dispatcher of the content layer when the dispatcher associated with the user input is absent in the annotation layer and the dispatcher associated with the user input exists in the content layer.

When the digital content is provided to the user terminal, the annotation managing module may provide annotation data associated with the user and annotation data associated with another user which is allowed to be published.

The annotation managing module may calculate, based on the annotation data, information associated with a number of annotation data for each digital content.

The annotation managing module may store the annotation data to have a data structure including at least one of an identification (ID) of the digital content, a positional value of the object based on a rendering of the digital content, and an actual data value corresponding to the object.

The annotation managing module may count a number of annotation data generated in each digital content, based on an ID of a corresponding digital content.

The annotation managing module may count a number of annotation data generated for each item of the digital content, based on a positional value of the object.

The annotation managing module may compare actual data corresponding to the object so as to count a number of annotation data generated for the same object

The annotation managing module may provide, a manager, the information associated with the number of annotation data for each digital content in response to a request from the manager who is authorized to manage digital content.

The annotation managing module may recommend, to the manager, at least one item based on a number of annotation data generated for each item of the digital content.

The annotation managing module may provide a graph indicating a number of annotation data generated for each item of the digital content

When the manager selects at least one bar indicating the number of annotation data, the annotation managing module may proceed with a page displaying content of an item corresponding to the selected bar.

According to still another aspect of the present invention, there is provided a non-transitory computer-readable medium comprising a program to provide a viewer function with respect to digital content, the non-transitory computer-readable medium including a content display code to display, on a screen of a touch sensing display, a content layer on which the digital content is rendered, an object recognition code to recognize an object selected by a user from the digital content by a touch input of the user to the touch sensing display, an annotation storage code to generate annotation data by applying an application associated with an annotation to the object, in response to a request from the user, an annotation count code to count a number of annotation data generated for each item of the digital content, and an annotation provision code to provide the number of annotation data for each item, in response to a request from the user.

Additional aspects, features, and/or advantages of the invention will be set forth in part in the description which follows and, in part, will be apparent from the description, or may be learned by practice of the invention.

### EFFECT

Embodiments may provide an annotation function in an electronic book (eBook) environment so as to add varied types of annotations to eBook content.

Embodiments may provide a user interface (UI) associated with an annotation on an eBook and thus, an annotation created on a corresponding content may be readily expressed and managed.

Embodiments may provide a UI that is capable of creating an annotation based on an eBook environment and is more convenient than a digital textbook, and thus, contents may be more effectively utilized.

Embodiments may provide a function of automatically extracting an item in which a plurality of annotations is written by a user in an eBook environment, and the function may be utilized in varied forms.

Embodiments may provide a UI environment that provides an item in which a plurality of annotations is written and thus, the item including the plurality of annotations may be recognized intuitively, and content of the item may be readily recognized.

Embodiments may provide a function of automatically recommending an item including annotations to an examiner when a plurality of students create annotations in digital content and thus, the examiner may readily and conveniently set exam questions.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating an annotation managing method that generates an annotation in digital content and manages the generated annotation according to an embodiment of the present invention;

FIG. 2 is a diagram illustrating a configuration of annotation data according to an embodiment of the present invention;

FIG. 3 is a flowchart illustrating a method of displaying annotation data according to an embodiment of the present invention;

FIGS. 4 and 5 are diagrams illustrating a user interface (UI) that displays annotation data according to an embodiment of the present invention;

FIG. 6 is a flowchart illustrating a method of processing an input interface associated with digital content according to an embodiment of the present invention;

FIG. 7 is a diagram illustrating an interface screen displayed when a discussion function utilizing an annotation is activated according to an embodiment of the present invention;

FIG. 8 is a flowchart illustrating a method of extracting an item in which a plurality of annotations is written according to an embodiment of the present invention;

FIG. 9 is a diagram illustrating an interface screen that provides an annotation graph with respect to an extracted item; and

FIG. 10 is a block diagram illustrating an eBook service system that provides an eBook service associated with digital content according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Example embodiments provides examples of a user terminal and a server system that provides an annotation function with respect to digital content, and manages an item in which an annotation are written.

Throughout the example embodiments, digital content refers to digitalized documents created based on a hypertext mark-up language (HTML) and an extensible mark-up language (XML), which are the standard languages of the Internet. In particular, the digital content may refer to electronic book (eBook)-based content.

The server system embodies a service model based on an eBook that provides digital content to the user terminal, and may provide an annotation function with respect to the digital content to the user terminal. That is, the server system may provide the annotation function that writes, on the digital content, an annotation requested by a user, and that utilizes an item, extracted from the digital content, in which a plurality of annotations is written. As an example, the server system may provide digital content to the user terminal in a form of an on-line service by maintaining an access with the user terminal over a network, for example, an Internet connection, a mobile communication, and the like, and may provide an annotation function with respect to the digital content. The server system may provide an eBook service having the same function, to an eBook dedicated terminal, a personal computer (PC), a tablet, a mobile terminal such as a smart phone, and the like. As another example, for a local environment of the user terminal, an eBook dedicated application, hereinafter, an eBook app, including a viewer function, an annotation function with respect to digital content, and the like may be provided. The eBook app basically provides a service environment for example, storing, managing, and consuming digital content in a local state of the user terminal. In addition, the eBook app may provide a service environment, for example, managing, consuming, and sharing digital content stored in the server system through an interoperation between the user terminal and the server system. Also, the eBook app may extract, from digital content, an item in which a plurality of annotations is written, may provide a number of annotation data for each content or for each item, and thus, may provide a user interface (UI) environment that enables a user to intuitively recognize an item including annotations.

The user terminal may provide a viewer function, an annotation function, and the like with respect to digital content, and may be embodied as one of an eBook dedicated terminal, a PC, a tablet, a portable terminal such as a smart phone, and the like, or a combination thereof. The user terminal may refer to any communication terminal that is capable of storing an eBook app for installation, and performing communication access with the server system.

The user terminal may include a touch sensing display as an example of a display device. A contact point between the touch sensing display and a user may correspond to at least one finger of the user, a stylus pen, or the like. Although the touch sensing display may use liquid crystal display (LCD) technologies, light emitting polymer display (LPD) technologies and the like, display technologies may not be limited thereto. The touch sensing display may further include other devices and proximity sensor arrays to determine at least one contact point with the touch sensing display.

The touch sensing display may display a UI screen such as a graphic user interface (GUI) including at least one window. The at least one window may display digital content through an eBook viewer, or may be used to display an annotation applied to the digital content. The GUI may recognize a user experience (UX) input based on a contact point of the user through varied input interfaces, for example, a gesture, an icon, and the like. In the GUI, different functions may be defined for each gesture motion or each icon, in advance. The user terminal may recognize a touch input of the user through the GUI of the touch sensing display, may respond to the recognized touch input, and may execute a corresponding function.

In the present embodiment, a function to select an object from digital content displayed on a screen of the touch sensing display, which is referred to as an object selection function, and an annotation function to apply an annotation to the selected object may be provided. At least one finger that touches the touch sensing display sustains its state for one second or a predetermined gesture motion defined in advance, for example, “<”, “>”, “{”, “}”, “(”, “)”, “[”, “]”, “┌”, “┐”, and the like is input, the object selection function may be recognized. When a menu associated with an annotation is selected after a predetermined object is selected through the object selection function or when a menu associated with an annotation is dragged and dropped to a desired object, the annotation function may be recognized.

Hereinafter, a method of generating and managing an annotation with respect to an object selected from eBook-based digital content, and a method of extracting, from digital content, an item in which a plurality of annotations is written and utilizing the extracted item will be described. The UI screen of the touch sensing display may have different configurations or different functions based on a type of a digital content service, an operation system, a UI environment, and the like. Although the present embodiment describes a general viewer screen of a smart phone, a tablet, and the like, a configuration and a function of the UI screen is not limited thereto and may be changed as desired by those skilled in the art.

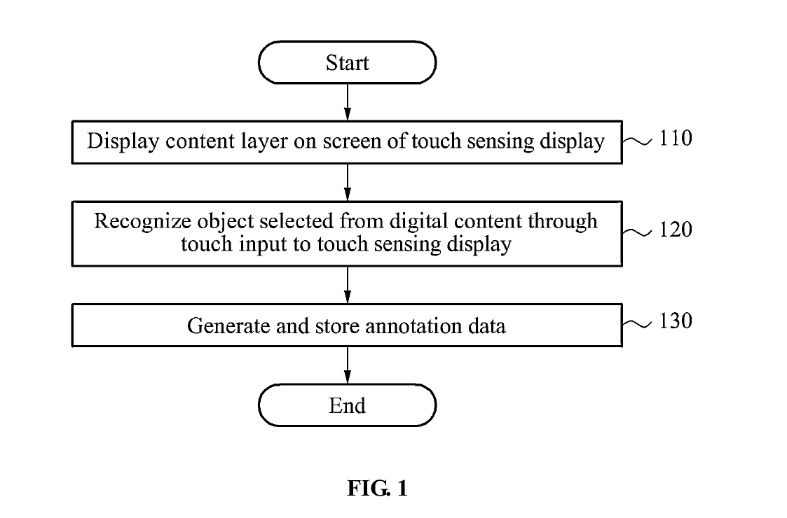

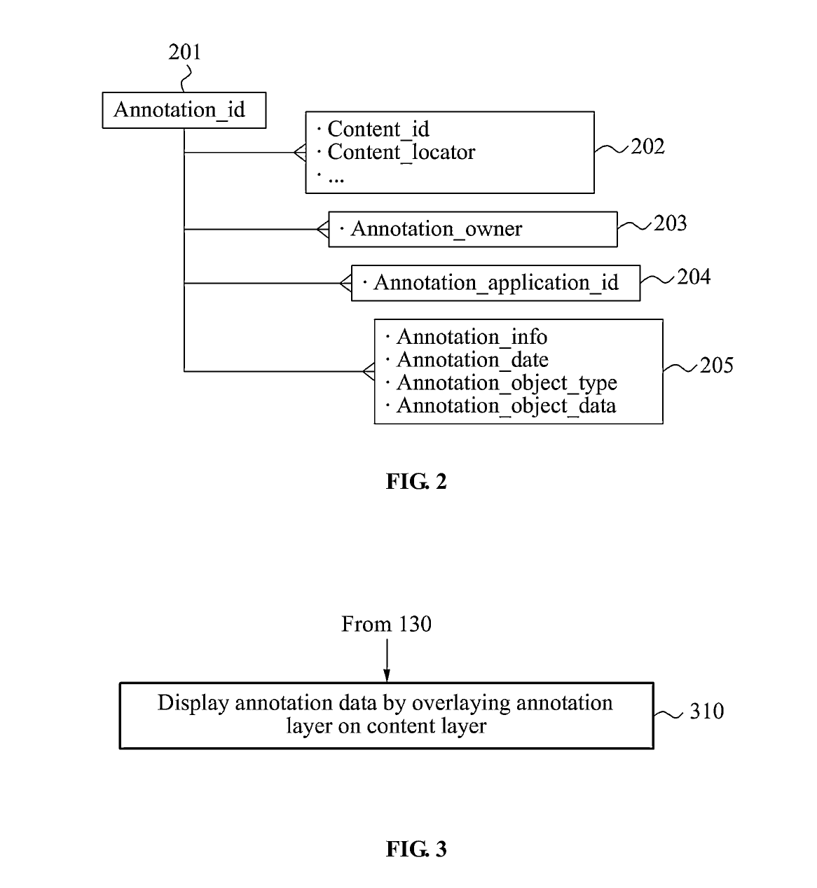

FIG. 1 illustrates an annotation managing method that generates an annotation in digital content and manages the generated annotation according to an embodiment of the present invention. FIG. 2 illustrates a configuration of annotation data according to an embodiment of the present invention. Hereinafter, a method of generating an annotation with respect to an object selected from digital content and an example embodiment will be described with reference to FIGS. 1 and 2.

In operation 110, digital content is displayed by a content display code of an eBook application (app) on a screen of a touch sensing display equipped in a user terminal. For example, the user terminal may execute an eBook app, directly, based on a local program or may execute the eBook app in a form of an online service through access with a server system. Therefore, the eBook app may be stored in a memory of the user terminal and may be executed by a processor included in the user terminal, or the eBook app may be executed by a browser of the user terminal for using a viewer environment provided by the server system. The eBook app may perform rendering with respect to digital content by a content display code. In this instance, a content layer on which the digital content is rendered may be output on a screen of the touch sensing display.

In operation 120, an object selected by a user from the digital content displayed on the touch sensing display may be recognized by an object recognition code of the eBook app. The object may refer to any object included in the digital content including a text using at least one of a word, a sentence, and a phrase as a unit, an image, a video, an audio, and the like. When an object selection function is recognized by a touch input of the user with respect to a predetermined object in the digital content displayed through the touch sensing display, an object corresponding to a location where the object selection function is recognized may be recognized as a target selected by the object selection function.

In operation 130, annotation data may be created by applying annotation requested by the user to the object selected by the object selection function, and the generated annotation data may be stored to be associated with the user by an annotation storage code of the eBook app. An annotation function may refer to any method that expresses additional information on digital content. For example, when varied types of applications, for example, a bookmark, underlining, a sign of importance, a memo, a discussion function, and the like, are additionally applied to an original content, all the data may be annotation data.

Here, annotation data generated for an object selected by a user may be configured to include at least one of an individual identification (ID) (Annotation_id) 201 of annotation data, information (Annotation_content_info) 202 associated with content of a corresponding object, information (Annotation_owner_info) 203 associated with an ID of the user who creates a corresponding annotation 203, information (Annotation_application_info) 204 associated with an application of an annotation applied to the object, and information (Annotation_info) 205 associated with data generated when an annotation with respect to the object is created. Annotation_id 201 is a unique value assigned when annotation data is generated, and may be utilized for providing information associated with content that an individual annotation is connected with and information associated with a location where the individual annotation is connected with the content. Annotation_content_info 202 may include an ID value (Content_id) of a corresponding digital content from which an object is selected, and may include a location value (Content_locator) of the object in the digital content. For example, Content_locator may denote information associated with a position stored when digital content is rendered, and may be expressed by a magnitude of an x-axis and a y-axis of the whole content, that is, by a content rendering width and a content rendering height when the digital content is rendered. Annotation_owner_info 203 may provide information associated with a user that creates an individual annotation, and a nickname, an ID, and the like registered, in advance, in the eBook app may be utilized. Annotation_application_info 204 may include a unique value (Annotation_application_id) assigned in advance for each application, for example, a bookmark, underlining, a sign of importance, a discussion function, and the like. Annotation_info 205 may include, as information associated with data generated when an annotation with respect to an object is created, a time (Annotation_date) of generating the annotation, information (Annotation_object_type) associated with a type that distinguishes a type of the object, and actual data (Annotation_object_data) corresponding to the object. When Annotation date is utilized, redundant annotations may be created with respect to the same object of the same content. Annotation_object_type may be classified into, for example, an audio, a video, an image, a text, and the like. Annotation_object_data may provide link information on a file of a low data in a form of a data value of contentl .xml in a range from 23345 bytes to 23450 bytes. Therefore, the user may select a desired object from digital content through the object selection function, and may apply a desired type of annotation to the selected object using the annotation function.

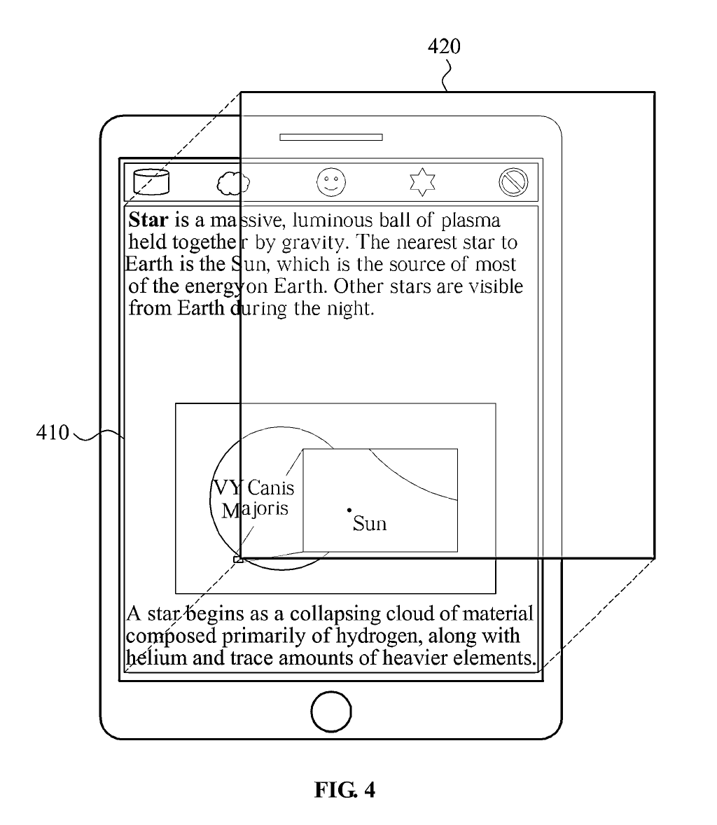

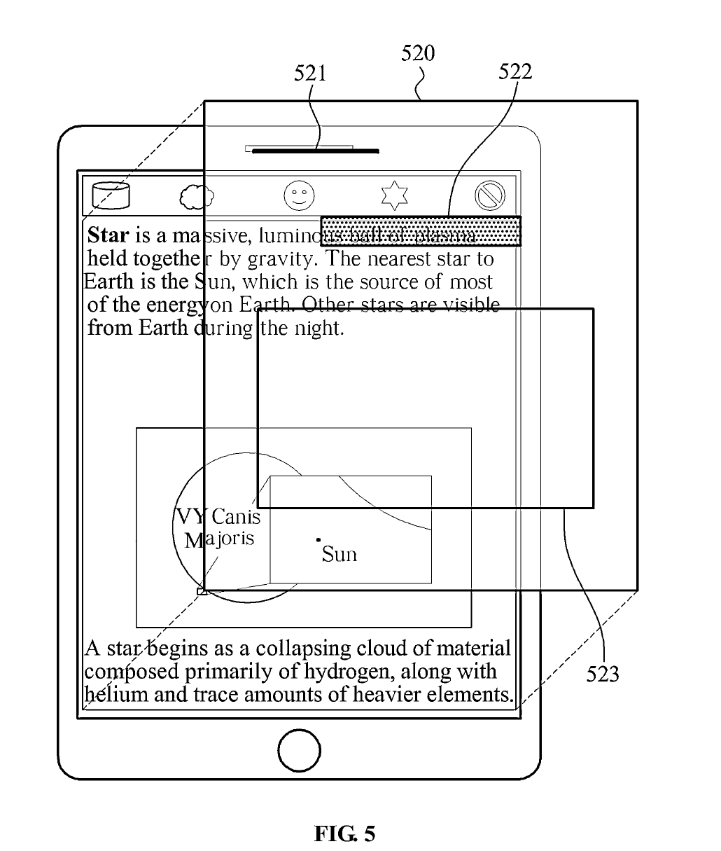

FIG. 3 illustrates a method of displaying annotation data according to an embodiment of the present invention. FIGS. 4 and 5 illustrate a user interface (UI) that displays annotation data according to an embodiment of the present invention. Hereinafter, a method of expressing annotation data generated in digital content, and an embodiment thereof will be described with reference to FIGS. 3 through 5.

In operation 310, the annotation data may be expressed by adding an additional layer on a rendered content in a form of an overlay, to express the annotation data on digital content. An eBook app may render the annotation data by an annotation display code. In this example, an annotation layer on which the annotation data is rendered is overlaid on a content layer so that the annotation data may be displayed on a touch sensing display.

For example, annotation data with respect to content may be provided by adding an annotation layer 420 on a content layer 410 on which the content is rendered, in a form of an overlay, as illustrated in FIG. 4. In this example, rendering may be performed on the annotation layer 420 based on annotation data associated with a predetermined object of the content, generated and stored by an annotation storage code. For example, when annotation data of “<Annotation_id: 1, Content_id: wikipedia.org/star, Annotation_owner: sunupnet, Annotation_application_id: basic_{—}02, Annotation_info: Ddf#gweD>” is rendered, underlining 521 may be expressed on a position of a corresponding object on an annotation layer 520. When annotation data of “<Annotation_id: 2, Content_id: wikipedia.org/star, Annotation_owner: sunupnet, Annotation_application_id: basic_{—}12, Annotation_info: JFH31k$%>” is rendered, a sign of importance 522 may be expressed on a position of a corresponding object on the annotation layer 520. When annotation data of <Annotation_id: 3, Content_id: wikipedia.org/star, Annotation_owner: sunupnet, Annotation_application_id: basic_{—}05, Annotation_info: KLJE8#CK>″ is rendered, a box 523 may be expressed on a position of a corresponding object on the annotation layer 520. When users publish annotation data associated with a selected object to other users, for example, friends of the user, or share the annotation data with other users, through a sharing function, a server system may collect annotation data that is allowed to be published to other users, through an external search engine, an application programming interface (API), and the like, so as to transmit the collected annotation data to a corresponding user terminal.

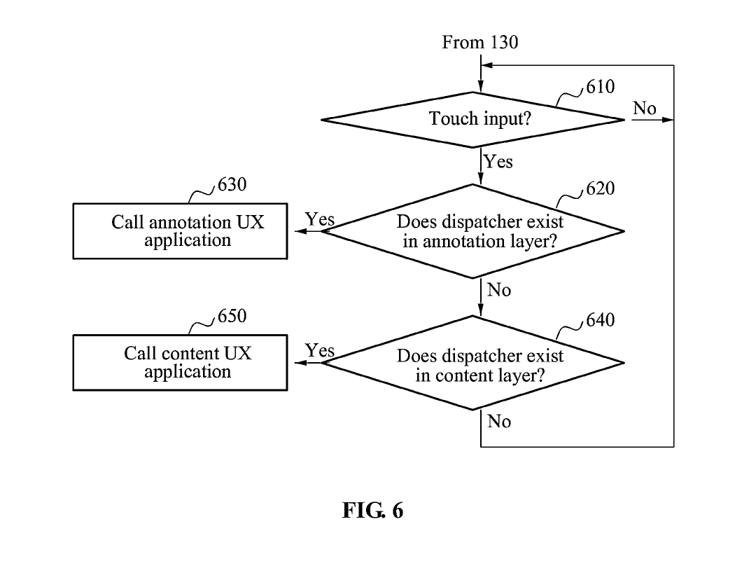

FIG. 6 illustrates a method of processing an input interface associated with digital content according to an embodiment of the present invention. Hereinafter, a method of processing an input interface when the input interface of an eBook app is activated, and an embodiment thereof will be described.

A touch input of a user input while an annotation layer is overlaid on a content layer may be processed to pass through a dispatcher of the annotation layer by an input processing code of the eBook app, and may be transferred to the content layer. For example, when a touch input interface with respect to the digital content is activated, whether a touch input from the user exists is continuously determined in operation 610. In this example, when a touch input exists, whether a UX dispatcher associated with the corresponding touch input exists in an annotation layer is determined in operation 620. When the UX dispatcher of the annotation layer exists, an annotation UX application corresponding to the UX dispatcher may be called in operation 630. When the UX dispatcher of the annotation layer is absent, whether a UX dispatcher exists in the content layer may be determined in operation 640. When the UX dispatcher of the content layer exists, a content UX application corresponding to the UX dispatcher may be called in operation 650.

Therefore, a user terminal and a server system to provide an annotation function may provide an annotation function with respect to digital content without additionally correcting a form of an existing digital content, and may generate, using varied annotation functions, an annotation of a desired standard with respect to content that is being read by the user, in addition to merely reading the content.

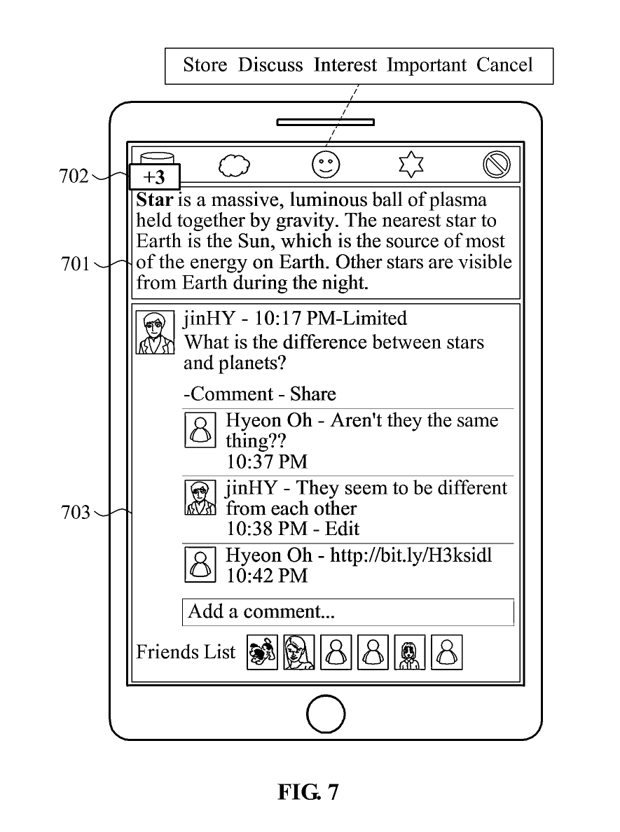

FIG. 7 illustrates an interface screen displayed when a discussion function utilizing an annotation is activated according to an embodiment of the present invention.

An eBook app may expand a scope of an annotation function so as to provide a discussion function that enables a user to discuss with a second user, for example, a friend of the user and the like, a selected object. For example, when the discussion function is activated and other users use the discussion function as illustrated in FIG. 7, a number of comments from users about the discussion may be displayed at a head of descriptions associated with a subject of the discussion. The user may invite the second user to the discussion by selecting the second user through a GUI of the eBook, and may enable the user to have a discussion with other users by publishing contents of the discussion through an external search engine or sharing the contents of the discussion through an API and the like. When the discussion function is activated, a UI screen may be displayed by a code associated with the discussion function as illustrated in FIG. 7. A plurality of windows may be displayed on the corresponding UI screen, and an object, for example, text, an image, and the like, selected by the user from digital content may be displayed on a first window 701. In this example, when other users use the discussion function with respect to the selected object, a number of comments 702 of the users about the discussion may be displayed on one side of the first window 701. The number of comments 702 may be displayed by receiving update information from a server system. Also, contents of the discussion with respect to the selected object may be displayed on a second window 703. In the second window 703, an item for adding a comment and an item for indicating users joining the discussion may be displayed. When the user publishes or shares the contents of discussion with respect to the selected object through a sharing function, the server system may collect comments of other users and transmit the collected comments to a corresponding user terminal.

Therefore, a user terminal and the server system may expand the scope of the annotation function so as to provide a function that enables the user to discuss, with other users, the selected object. The user may readily and conveniently discuss digital content without using an additional system, for example, Wikipedia and the like.

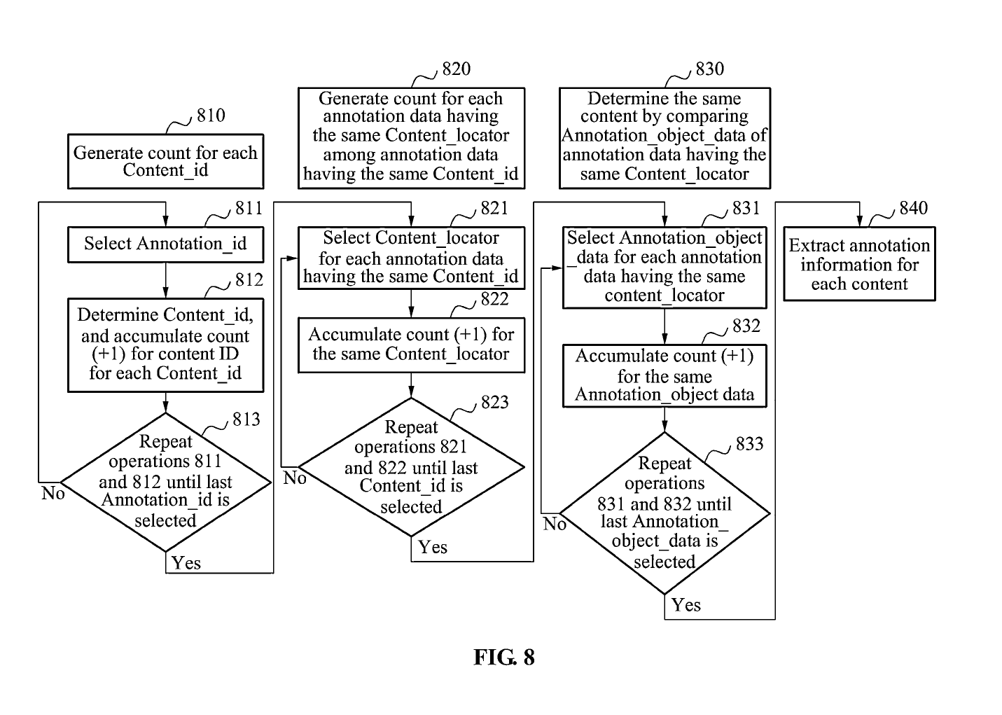

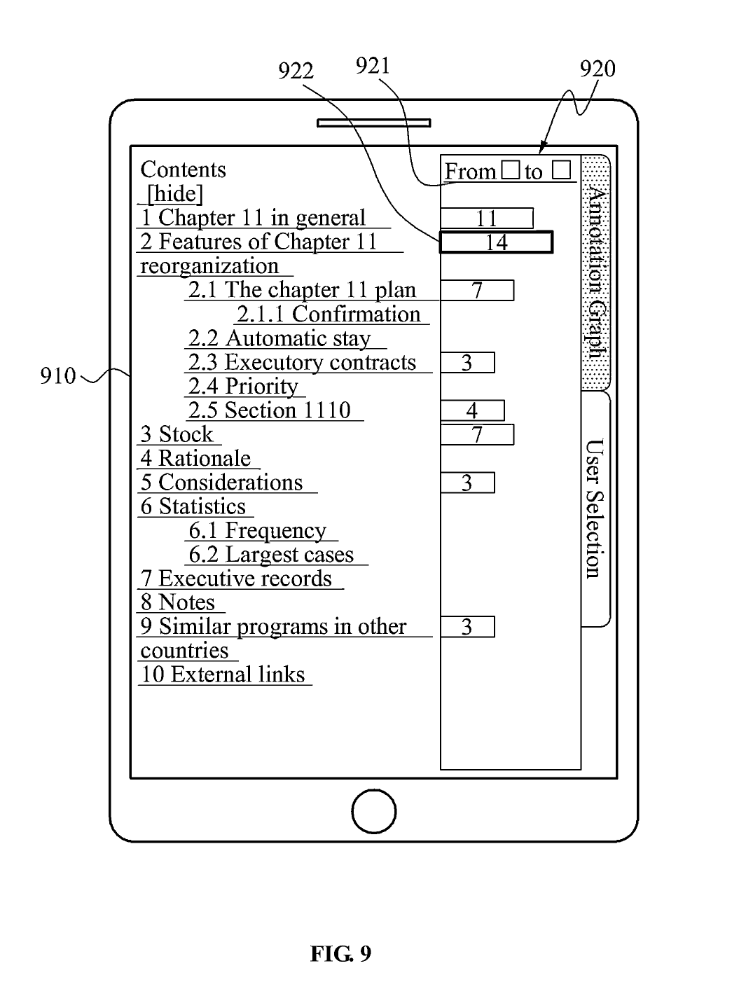

FIG. 8 illustrates a method of extracting an item in which a plurality of annotations is written according to an embodiment of the present invention, and FIG. 9 illustrates an interface screen that provides an annotation graph with respect to an extracted item. A method of extracting, from digital content, an item in which a plurality of annotations is written so as to provide the extracted item, and an embodiment thereof will be described with reference to FIGS. 8 and 9.

Redundant information may be retrieved by an annotation count code of an eBook app, based on the structure of the annotation data described in FIG. 2 and information associated with content that an individual annotation is connected with, and information associated with a location where the individual annotation is connected with the content. Therefore, a user terminal or a server system may collect all annotation data written by users subscribing to digital content, and may use the collected annotation data for information retrieval and thus, an item in which a plurality of annotations is written may be extracted from the digital content. As an example, a number of annotation data generated from the same content may be counted based on Content_id of digital content connected with Annotation_id of annotation data. As another example, a number of annotation data generated from the same item may be counted for each item that distinguishes contents of digital content, for example, a paragraph, a chapter, and the like, based on Content_locator of an object connected with Annotation_id of annotation data. As still another example, a number of annotation data generated, with respect to the same object may be counted based on Annotation_object_data of an object connected with Annotation_id of annotation data.

A procedure of determining a redundant annotation may be described with reference to FIG. 8.

In operation 810, a count of Annotation_id may be generated for each Content_id. To perform operation 810, Annotation_id of all pieces of annotation data is sequentially selected in operation 811, so as to determine Content_id connected with Annotation_id and to accumulate a count (+1) with respect to a content ID temporarily assigned for each Content_id in operation 812. In operation 813, operations 811 and 812 are repeatedly performed until the last Annotation_id is selected.

In operation 820, a count may be generated for each annotation data having the same Content_locator among annotation data having the same Content_id. To perform operation 820, Content_locator may be sequentially selected from each annotation data having the same Content_id in operation 821, and a count may be accumulated with respect to the annotation having the same Content_locator in operation 822. In operation 823, operations 821 and 822 may be repeatedly performed until the last Content_id is selected.

In operation 830, redundant information may be determined by comparing Annotation_object_data of annotation data having the same Content_locator. To perform operation 830, Annotation_object_data may be sequentially selected from each annotation data having the same Content_locator in operation 831, and a count may be accumulated with respect to annotation data having the same Annotation_object_data in operation 832. In operation 833, operations 831 and 832 may be repeatedly performed until the last content locator is selected.

In operation 840, information associated with a number of annotation data for each digital content may be calculated through the redundant information retrieval performed based on annotation data using the procedure described in the foregoing.

In addition, information associated with the number of annotation data for each digital content may be provided based on an annotation provision code of an eBook, in response to a request from a user or a manager who has an authority of managing digital content. To provide the information associated with the number of annotation data, the user terminal or the server system may provide a user interface (UI) through which the information associated with the number of annotation data may be determined.

For example, a UI in which a number of annotation data is recognizable for each chapter based on a configuration of content, for example, each individual chapter, may be provided. As illustrated in FIG. 9, an annotation graph 920 showing a number of annotation data generated in content of each chapter may be displayed, for each chapter, on a page 910 that provides a chapter list of digital content. In this example, a menu 921 that designates a range of the number of annotation data is provided on a UI screen where the annotation graph 920 is displayed. When the range of the number of annotation data is designated by the user or the manager, the annotation graph 920 may show a number of annotation data only for chapters in the designated range. The annotation graph 920 may be configured to selectively include corresponding content based on the menu 921 for the number of annotation data, by the annotation provision code of an eBook. The annotation graph 920 may be expressed in a form where at least one chapter having a high number of annotation data based on a number of annotation data of each chapter is recommended to the user or the manager. For example, a bar 922 of a chapter having a highest number of annotation data in the graph 920 may be expressed in a different form, for example, a different color, and the like, from bars of other chapters. For example, when a question associated with digital content is planed to be set for exam in an educational course, a UI environment that automatically extracts an item including annotations written by a plurality of students and that recommends the corresponding item to an examiner, that is, the manager, may be provided. When the user or the manager clicks at least one annotation bar, the UI environment providing the annotation graph 920 may provide a page link that corresponds to a link to a page showing content of a chapter corresponding to the selected bar.

Thus, the user terminal and the server system may provide an annotation function, and may provide a UI environment where a number of annotation data is recognizable for each digital content by extracting, from digital content, an item in which a plurality of annotations is written.

The method of generating, managing, expressing annotations described with reference to FIGS. 1 through 9 may include simplified operations or include additional operations. Also, at least two operations may be combined, and an order of the operations may be changed.

Hereinafter, the method of generating, managing, and expressing the annotation, and embodiments associated with apparatuses thereof will be described.

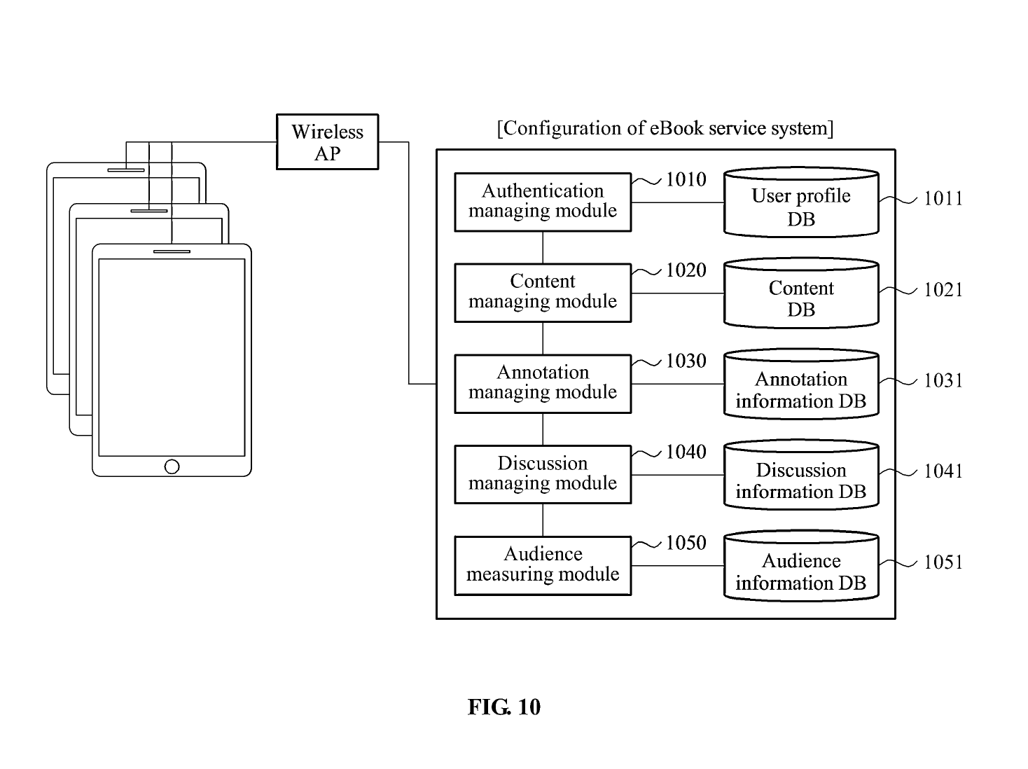

FIG. 10 illustrates an eBook service system, that is, a server system that provides an eBook service associated with digital content according to an embodiment of the present invention.

As illustrated in FIG. 10, the eBook service system may include an authentication managing module 1010, a user profile database (DB) 1011, a content managing module 1020, a content DB 1021, an annotation managing module 1030, an annotation information DB 1031, a discussion managing module 1040, a discussion information DB 1041, an audience measuring module 1050, and an audience information DB 1051. The authentication managing module 1010, the content managing module 1020, an annotation managing module 1030, a discussion managing module 1040, and an audience measuring module 1050 may be separately included in the system or may be configured to be an integrated module. Each module may independently perform a function or may be dependent upon at least one different module to perform a function. The user profile DB 1011, the content DB 1021, the annotation information DB 1031, the discussion information DB 1041, the audience information DB 1051 may be used as an individual DB system or may be integrated into a single DB system.

The authentication managing module 1010 may store personal information associated with a user in the user profile DB 1011 and may manage the stored personal information. The personal information may include authentication information and profile information associated with the user, registered for the eBook service in a system. The authentication managing module 1010 may authenticate the user based on the authentication information when the authentication is required, and the profile information may be stored or edited in response to a request from the user.

The content managing module 1020 may store eBook-based digital content in the content DB 1021 and may manage the stored eBook-based digital content. The content managing module 1020 may continuously manage the digital content stored in the content DB 1021 by maintaining and updating the digital content. The content managing module 1020 may provide a search function so that the user searches for digital content through the content DB 1021. The content managing module 1020 may provide desired digital content to a user terminal in response to a request from the user via the user terminal, so as to provide a viewer function with respect to the digital content. In this example, the content managing module 1020 may provide, to the user terminal, a content layer on which the digital content is rendered. The content managing module 1020 may search for information from the Internet in conjunction with the content DB 1021 and with a search server that provides a search engine for information on the Internet. For example, the content managing module 1020 may provide a search function that recognizes an object selected by the user from the digital content through the user terminal, searches for information from the Internet using the recognized object as a keyword, and provides a search result.

The annotation managing module 1030 may provide an annotation function with respect to the digital content, and may maintain and manage the annotation data associated with the digital content. The annotation function may include any method in which a user expresses additional information to digital content.

As an example, when varied additional application functions, for example, a book mark, underlining, a sign of importance, a memo, and the like are additionally applied to an original content, all the data may be annotation data. Therefore, the annotation managing module 1030 may recognize the object selected by the user via the user terminal, may generate annotation data by applying an annotation application to the object in response to a request from the user, and may store the generated annotation data in the annotation information DB 1031 to be associated with the user. The annotation managing module 1030 may render annotation data on an annotation layer that is overlaid on the content layer, and may provide the annotation data to the user terminal. Therefore, the user may select a predetermined object from digital content that is currently being used, through an object selection function. Subsequently, functions, for example, a bookmark, underlining, a sign of importance, a memo, and the like may be applied to the object.

In addition, the annotation managing module 1030 may calculate, using annotation data, information associated with a number of annotation data for each digital content. For example, the annotation managing module 1030 may count a number of annotation data generated from the same content, based on Content_id of digital content connected with Annotation_id of annotation data. For another example, the annotation managing module 1030 may count a number of annotation data generated from the same item, for each item of the digital content, for example, a paragraph, a chapter, and the like, based on Content_locator of an object connected with Annotation_id of annotation data. As another example, the annotation managing module 1030 may count a number of annotation data generated with respect to the same object, based on Annotation_object_data of an object connected with Annotation_id of annotation data. Accordingly, the annotation managing module 1030 may provide, to the user or a manager, a UI that enables the user or the manager to recognize information associated with the number of annotation data for each content. As an example, the annotation managing module 1030 may recommend at least one item to the user or the manager, based on a number of annotation data generated for each item of the digital content. As another example, the annotation managing module 1030 may provide a graph indicating the number of annotation data generated for each item of the digital content, and may also provide a graph indicating a number of annotation data for items within a designated range, when the user or the manager designates the range associated with a number of annotation data. As still another example, the annotation managing module 1030 may display a bar of an item having a highest number of annotation data in a different form from other bars in an annotation graph. Also, there may be provided a function that provides a link to a page showing content of an item corresponding to a predetermined bar when the predetermined bar is selected by the user or the manager. Therefore, the annotation managing module 1030 may extract, from the digital content, an item in which a plurality of annotations is written and thus, may provide a UI environment where the number of annotation data is recognizable for each digital content.

The discussion managing module 1040 may provide a discussion function, that is, a sharing function, with respect to the digital content, and may maintain and manage discussion information associated with the digital content using the discussion information DB 1041. The discussion function may refer to any method that shares opinions about the digital content among a plurality of users. For example, the user may register, in the discussion information DB 1041 through the discussion function, an opinion or a question associated with digital content that is currently being used. Accordingly, the user may share the opinion with a friend or another user or may have a response for the question, through the discussion managing module 1040. The discussion managing module 1040 may receive, from the user terminal, contents of the discussion with respect to a predetermined object, and may provide the contents of the discussion received from the user terminal to a corresponding user terminal determined based on user profile information of the authentication managing module 1010.

The audience measuring module 1050 may measure an audience with respect to all digital contents, and may maintain and manage audience information associated with the digital content through the audience information DB 1051. For example, the audience measuring module 1050 may survey a magnitude of use and a form of use with respect to digital content provided through an eBook service, and a survey result may be utilized as varied statistical information, for example, a content ranking, a content usage index, and the like.

Although a configuration of the user terminal that directly displays digital content provided from an eBook service system is not illustrated, the user terminal basically includes a touch sensing display, a remote controller function, a memory, at least one processor, and at least one program. In this example, the at least one program may be stored in the memory, and may be configured to be executed by the at least one processor. The at least one program may include a program associated with an annotation function. The user terminal may support varied communication protocols, for example, a code division multiple access (CDMA), a Wi-Fi technology, a Bluetooth technology, an Ethernet technology, and the like.

The various functions of the user terminal and the eBook service system may be embodied by hardware and/or software including an integrated circuit appropriate for at least one signal process and/or an application.

The method according to the above-described embodiments of the present invention may be recorded in non-transitory computer readable media including program instructions to implement various operations embodied by a computer.

The method according to the above-described embodiments of the present invention may be recorded in non-transitory computer readable media including a program, and the program may include a content display code to display a content layer on which digital content is rendered, on a screen of a touch sensing display, an object recognition code to recognize an object selected by a user from the digital content by a touch input of the user to the touch sensing display, an annotation storage code to generate annotation data by applying, to the object, an application associated with an annotation in response to a request from the user, and to store the generated annotation data to be associated with the user, an annotation display code to display an annotation layer on which the annotation data is rendered, on the content layer in a form of an overlay, and an input processing code to process a touch input inputted while the annotation layer is being overlaid on the content layer by enabling the touch input to go through a dispatcher of the annotation layer and transferring the touch input to the content layer. The method according to the above-described embodiments of the present invention may be recorded in non-transitory computer readable media including a program, and the program may further include an annotation count code to count a number of annotation data generated for each item of the digital content, and an annotation provision code to provide the number of annotation data for each item, in response to a request from the user. The program may be configured as a PC-based program or a mobile terminal dedicated application, for example, a smartphone application, a feature phone virtual machine (VM), and the like, and an IPTV dedicated application, for example, an advanced common application protocol-Java (ACAP-J) or a Java application operated in an open cable application platform (OCAP) or advanced common application protocol (ACAP) middleware environment. The program may be stored in a memory of the user terminal and/or the eBook service system, and may be configured to be executed by at least one processor in the user terminal and/or the eBook service system.

The media may also include, alone or in combination with the program instructions, data files, data structures, and the like. The program instructions recorded in the media may be designed or configured for the present invention, or may be generally used since it is published to those skilled in the art. The file system may be recorded in non-transitory computer readable media.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A user terminal that provides a viewer function with respect to digital content, the terminal comprising:
a touch sensing display;
at least one processor;
a memory; and
at least one program,
wherein the at least one program is stored in the memory so as to be executed by the at least one processor, and comprises:
a content display code to display a content layer on which the digital content is rendered, on a screen of the touch sensing display;
an object recognition code to recognize an object selected by a user from the digital content by a touch input of the user to the touch sensing display; and
an annotation storage code to generate annotation data by applying, to the object, an application associated with an annotation in response to a request from the user, and to store the generated annotation data to be associated with the user.

2. The terminal of claim 1, wherein the annotation storage code stores the annotation data to have a data structure including at least one of an identification (ID) of the digital content, a positional value of the object based on a rendering of the digital content, and an actual data value corresponding to the object.

3. The terminal of claim 1, wherein the program further comprises an annotation display code to display an annotation layer on which the annotation data is rendered, on the content layer in a form of an overlay.

4. The terminal of claim 3, wherein, the program further comprises an input processing code to process the touch input by enabling the touch input to go through a dispatcher of the annotation layer and transferring the touch input to the content layer when the touch input is input while the annotation layer is being overlaid on the content layer.

5. The terminal of claim 4, wherein, when the touch input is inputted, the input processing code calls:
an application corresponding to a dispatcher of the annotation layer when the dispatcher associated with a user input exists in the annotation layer; and
an application corresponding to a dispatcher of the content layer when the dispatcher associated with the user input is absent in the annotation layer and the dispatcher associated with the user input exists in the content layer.

6. The terminal of claim 1, wherein the program further comprises:
an annotation count code to count, for each item of the digital content, a number of annotation data generated in a corresponding item; and
an annotation provision code to provide the number of annotation data for each item, in response to a request from the user.

7. A server that provides an on-line service associated with digital content to a user terminal that accesses the server via Internet communication, the server comprising:
a content managing module to provide the digital content to the user terminal;
an annotation managing module to recognize an object selected by a user from the digital content, and to generate annotation data by applying an application associated with an annotation to the object in response to a request from the user; and
an annotation information database (DB) to store the annotation data to be associated with the user and to maintain the stored annotation data,
wherein:
the user terminal includes a touch sensing display so as to display the digital content provided from the server on a screen of the touch sensing display, and
the annotation managing module recognizes the object by a touch input of the user to the touch sensing display.

8. The server of claim 7, wherein the annotation managing module renders the annotation data on an annotation layer that is overlaid on a content layer.

9. The server of claim 8, wherein, when the touch input is inputted while the annotation layer is being overlaid on the content layer, the user terminal calls:
an application corresponding to a dispatcher of the annotation layer when the dispatcher associated with a user input exists in the annotation layer; and
an application corresponding to a dispatcher of the content layer when the dispatcher associated with the user input is absent in the annotation layer and the dispatcher associated with the user input exists in the content layer.

10. The server of claim 7, wherein, when the digital content is provided to the user terminal, the annotation managing module provides annotation data associated with the user and annotation data associated with another user which is allowed to be published.

11. The server of claim 7, wherein the annotation managing module calculates, based on the annotation data, information associated with a number of annotation data for each digital content.

12. The server of claim 11, wherein the annotation managing module stores the annotation data to have a data structure including at least one of an identification (ID) of the digital content, a positional value of the object based on a rendering of the digital content, and an actual data value corresponding to the object.

13. The server of claim 12, wherein the annotation managing module counts a number of annotation data generated in each digital content, based on an ID of a corresponding digital content.

14. The server of claim 12, wherein the annotation managing module counts a number of annotation data generated for each item of the digital content, based on a positional value of the object.

15. The server of claim 12, wherein the annotation managing module compares actual data corresponding to the object so as to count a number of annotation data generated for the same object.

16. The server of claim 11, wherein the annotation managing module provides, a manager, the information associated with the number of annotation data for each digital content in response to a request from the manager who is authorized to manage digital content.

17. The server of claim 16, wherein the annotation managing module recommends, to the manager, at least one item based on a number of annotation data generated for each item of the digital content.

18. The server of claim 16, wherein the annotation managing module provides a graph indicating a number of annotation data generated for each item of the digital content

19. The server of claim 18, wherein, when the manager selects at least one bar indicating the number of annotation data, the annotation managing module proceeds with a page displaying content of an item corresponding to the selected bar.

20. A non-transitory computer-readable medium comprising a program to provide a viewer function with respect to digital content, the non-transitory computer-readable medium comprising:
a content display code to display, on a screen of a touch sensing display, a content layer on which the digital content is rendered;
an object recognition code to recognize an object selected by a user from the digital content by a touch input of the user to the touch sensing display;
an annotation storage code to generate annotation data by applying an application associated with an annotation to the object, in response to a request from the user;
an annotation count code to count a number of annotation data generated for each item of the digital content; and
an annotation provision code to provide the number of annotation data for each item, in response to a request from the user.
